(19) United States
(12) Patent Application Publication
(10) Pub. No.: US 2009/0248713 A1
(43) Pub. Date: Oct. 1, 2009

(54) METHOD AND APPARATUS FOR SYNCHRONIZING METADATA AND MEDIA BASED ON UPNP PROTOCOL

(75) Inventors: Joon Young Park, Libertyville, IL (US); Liang Gan, Beijing (CN)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/058,801

(22) Filed: Mar. 31, 2008

(51) Int. Cl. G06F 17/30

(52) U.S. Cl. 707/100; 707/E17.005

(57) ABSTRACT

A method and apparatus to synchronize multiple UPnP content directory services without using CDS tracking or content synchronization service is disclosed. The method may include discovering mediaservers coupled to a network, comparing respective metadata fields from the discovered mediaservers, updating the metadata fields based on the comparison. A control point gets metadata of media objects that need to be synchronized. The control point invokes a comparemetadata action to ascertain the differences in the objects, upon acquiring the difference between the metadata parameters of a sync object in a first CDS with sync pairing object in a second CDS the control point invokes appropriate UPnP actions to ensure the two objects are synced.

### BACKGROUND OF THE INVENTION

1. Field of the Invention

The invention relates to synchronizing content provided by content directory services of Universal Plug and Play (UPnP) devices.

2. Introduction

It is common to store media items such as pictures and music files on a variety of personal electronic devices. For example, many users store such information on mobile phones, Personal Digital Assistants (PDAs), mobile and desktop computers. Often it is useful to have the same files stored on multiple devices, and it is preferable that information or metadata associated with each file is current and synchronized across all devices on which the files are stored. A standard that facilitates media sharing or decentralizing of media is the Universal Plug and Play standard (UPnP). The UPnP protocol allows different devices (UPnP devices) to interact seamlessly, and provides a foundation for handling content such as music, images, and videos in a local network. UPnP further enables such content to be accessed from various devices in a network, without regard for where the media is actually stored, and enables content and metadata transfer and/or rendering under the command of any control device in a network. UPnP devices, for example, can serve as media servers to provide storage of media content and metadata; media renderers to enable viewing of media content; and control point functionality to control the media interaction between servers and renderers.

UPnP audio/video (AV) technology, which enables a user to enjoy multimedia content such as AV content, based on the UPnP technology, is described in the UPnP AV specification. According to the UPnP AV specification, UPnP AV architecture includes a media server providing a multimedia file using a ContentDirectory service (CDS), a media renderer rendering the multimedia file provided by the media server, and a control point (CP) controlling the media server and the media renderer to communicate with each other. CDS implements tree-like structures to support various types of content (music, images, videos, albums, playlists) with all the nodes providing their own metadata fields to describe the item. Further, CDS acts as a database to store the metadata of content so that the content can be easily queried and browsed from various control points in the network. The CP identifies the metadata from the CDS and requests the media renderer to render the metadata.

For the reasons stated above, and for other reasons stated below which would become apparent to those skilled in the art upon reading and understanding the present specification, there is a need in the art to synchronize content across a network.

### SUMMARY OF THE INVENTION

A method and apparatus to synchronize multiple UPnP content directory services without using CDS tracking or content synchronization service is disclosed. The method may include discovering mediaservers coupled to a network, comparing respective metadata fields from the discovered mediaservers, updating the metadata fields based on the comparison. A control point gets metadata of media objects that need to be synchronized. The control point invokes a comparemetadata action to ascertain the differences in the objects, upon acquiring the difference between the metadata parameters of a sync object in a first CDS with sync pairing object in a second CDS the control point invokes appropriate UPnP actions to ensure the two objects are synced.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a synchronization architecture in accordance with a possible embodiment of the invention;

FIG. 2 illustrates an exemplary block diagram of a ControlPoint(CP) and ContentDirectory Service(CDS) in accordance with a possible embodiment of the invention;

FIG. 3 is an exemplary flowchart illustrating one possible synchronizing process in accordance with one possible embodiment of the invention;

FIG. 4 is an exemplary flowchart illustrating one possible process for content synchronization with CompareMetadata action in accordance with one possible embodiment of the invention; and

FIG. 5 illustrates an exemplary diagram of a process for synchronizing two CDS devices in accordance with a possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The invention comprises a variety of embodiments, such as a method and apparatus and other embodiments that relate to the basic concepts of the invention.

This invention concerns a method, an apparatus, and an article of manufacture to synchronize a plurality of MediaServers or CDS devices embodied in the MediaServers, a CDS device, and a system according to exemplary embodiments of the present invention will be described in detail with reference to the accompanying drawings. The MediaServers or CDS devices are arranged to form a UPnP architecture and named as defined by the UPnP specification. However, the scope of the present invention will not be affected by any network system or the names of the devices.

Below are definitions which will be used throughout in the discussion:

Synchronization Object Pairing is a data structure that identifies which object in a particular CDS is paired with an object in the partner CDS. The synchronization object pairing information can be stored in both partner devices and ControlPoint as a property UPnP object. For example, upnp:syncInfo::objectPair.

Synchronization Pairing is the data structure that identifies a group of synchronization objects where identical synchronization policy will be applied.

Synchronization Partnership is a data structure that describes a synchronization operation between two specific CDSs. These two CDSs are called partners. A synchronization partnership contains multiple synchronization pairings. A synchronization partnership contains policy information that is applicable to all the pairings contained within that partnership. If a pairing has its own policy information then the pairing policy overrides partnership policy for that specific pairing.

Synchronization Relationship is a data structure that describes a synchronization operation between two or more CDSs. A synchronization relationship is composed of one or more synchronization partnerships and each partnership is composed of one or more synchronization pairings.

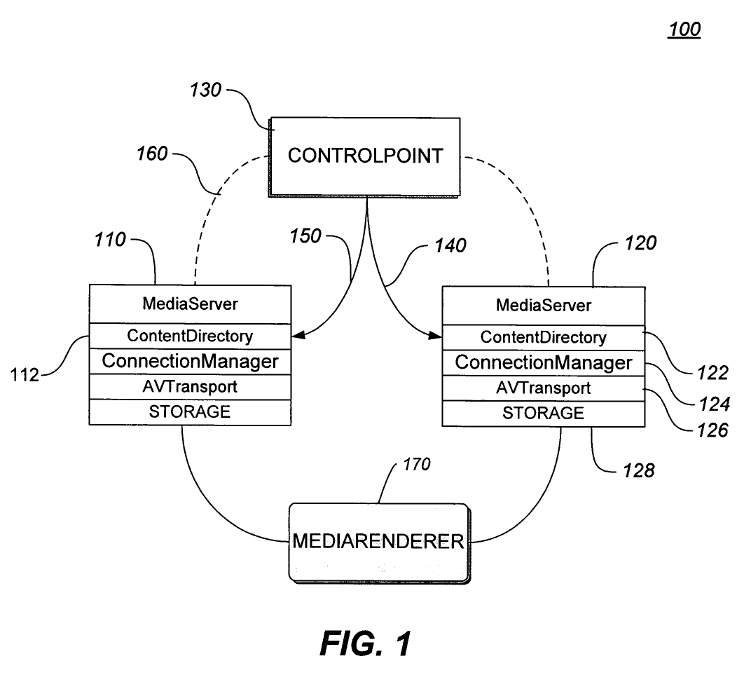

FIG. 1 illustrates an exemplary diagram of an UPnP network 100 for pervasive peer-to-peer network connectivity of personal computers and intelligent devices or appliances (CDS) in accordance with a possible embodiment of the invention. UPnP builds on internet standards and technologies, such as TCP/IP, HTTP, and XML, to enable these devices to automatically connect with one another and work together to make a networking environment. In particular, the UPnP network 100 includes ControlPoint 130, a first MediaServer 110, a second MediaServer 120, MediaRenderer 170, and network mechanism 160. Mediaservers and mediarenderers are sometimes referred to individually as a content directory service device. It should be noted that additional MediaServers are possible and that when communicating these MediaServers can be called a destination MediaServer and source MediaServer based on the flow of information relative to each other. A ControlPoint 130 in UPnP network 100 is a controller capable of discovering and controlling one or more attached intelligent devices such as first MediaServer 110 and second MediaServer 120. After discovery a MediaServer, ControlPoint 130 could: retrieve the device description and get a list of associated services from a MediaServer's ContentDirectory such as second CDS 122 and first CDS 112; retrieve service descriptions for services in the ContentDirectory; invoke actions to control the service in a MediaServer; and subscribe to the service's event source such as changes in content. Anytime the state of the service changes, the affected MediaServer will send an event to ControlPoint 130.

The UPnP network 100 is illustrated with a first MediaServer 110 and a second MediaServer 120. A MediaServer as used herein is a UPnP compliant device having container of services and/or a part of nested devices capable of providing services or rendering a desired output. That is, the MediaServer can be one or both a service content holder and mediarenderer. A MediaServer (MS) on the UPnP network 100 stores audio, video, text, graphics, and images for rendering or providing to other devices on the UPnP network 100. A MediaRenderer 170 (MR) on the UPnP network 100 plays back the content stored at the MS. A MS device and MR device can be both a holder and a player of content based on a desired functionality. Examples of MediaRenderers are VCR devices that may consist of a tape transport service, a tuner service, and a clock service. A TV/VCR combo device would consist not just of services, but a nested device as well. Other examples include DVD players, portable MP3 player, satellite radio receiver, AM/FM radio receiver, satellite television, portable music player, portable computer, wireless radio, wireless telephone, portable digital video recorder, cellular telephone, mobile telephone, personal digital assistant PDA), or combinations of the above, for example.

The MediaServer device contains or has access to a data stream which is stored locally, for example, or is received externally. The MediaServer device has access to the stream data and is able to transmit an associated data stream to another network station via the network 160. Alternative connections such as link 150 and link 140 are provided to forward a StartPeerSync message to CDS 112 and CDS 122 in order to facilitate synchronization. In this case, the data stream is transmitted using a transfer protocol in line with the transmission medium available in the network 160. The data transmission formats supported by the MediaServer are explicitly defined in the ContentDirectory service (CDS) such as first CDS 112 and second CDS 122 for every possible resource. Typically, the device type MediaServer can be assigned to devices such as VCR, CD/DVD player, camera, camcorder, PC, set-top box, satellite, electronic device, cellular phone, PDA, receiver, audio tape player, etc. To select a particular content, a module for a ContentDirectory is usually implemented in the MediaServer in line with the UPnP standard of the UPnP network 100. In addition, the ConnectionManager such CM 124 communicates with ControlPoint 130 when setting up a connection to a MediaRenderer.

A MediaRenderer device receives the data stream transmitted by the MediaServer and outputs it in a desired format such as audio, video, images, text, or other machine stream. In the same way, the MediaRenderer device likewise contains an implementation of the ConnectionManager 124 module for the communication with ControlPoint 130 when setting up a connection. In addition, the MediaRenderer device contains an implementation of a rendering control module (not shown). This module receives commands for setting reproduction characteristics such as volume, tone, picture definition, contrast, brightness, color and so on and implements these commands. As an example of devices to which the MediaRenderer device type should be assigned in the home network, mention is made of a TV set, a stereo amplifier and an MP3 player. Depending on the transmission format implemented, the MediaServer or the MediaRenderer also has an AVTransport 126 service which is used to control the data transfer and the reproduction (e.g. PLAY, STOP, FAST FORWARD, etc.). A storage module 128 stores metadata, stores content, and stores control information needed to operate a MediaServer.

Different categories of UPnP devices will be associated with different sets of services and embedded devices. Consequently, different UPnP working groups will standardize on the set of services that a particular device type will provide. All of this information is captured in an XML (Extensible Markup Language) device description document that the MediaServer such the second MediaServer 120 maintains in a repository such as storage device 128. The XML document describes the services, the parameters for objects, and description of the device. A service can be model as state variables describing a set of actions that are within the UPnP device capabilities. For instance, a clock service could be modeled as having a state variable, current_time, which defines the state of the clock, and two actions, set_time and get_time, which allow you to control the service. This information is part of an XML service description standardized by the UPnP community. A uniform resource locator (URL) pointer to these service descriptions is contained within the device description document or XML document. The service descriptors lend themselves to being described as mediaserver metadata fields. For example, metadata parameter for a synchronization object stored in MediaServer 110 is described in an XML document like:

<item id=“A1” parentID=“00000001” restricted=“1”>
<dc:title>music1</dc:title>
<dc:artist>unKnow</dc:creator>
<dc:creator>Frank</dc:creator>
<upnp:class>object.item</upnp:class>
</item>

In yet another example, the metadata parameter for a sync object stored in MediaServer 120 is like:

<item id=“B1” parentID=“00000002” restricted=“1”>
<dc:title>I will always love you</dc:title>
<dc:artist>Sting</dc:creator>
<dc:producer>Sony</dc:producer>
<upnp:class>object.item</upnp:class>
</item>

The ControlPoint 130 device coordinates the data transport between MediaServers and MediaRenderers in UPnP network 100. The controlpoint 130 contains synchronization information to facilitate exchanging of objects or content between the networked mediaservers. Additionally, controlpoint 130 is likewise used to implement the control commands from the operator and forward them to the appropriate device's AVTransport. Examples of control commands are Play, Stop, Pause, Fast forward, Rewind, in particular. The ControlPoint 130 device is active, in particular, when setting up a logical connection between two network stations. It is likewise used when, after an AVTransport has fulfilled its purpose.

In operation the MediaServer/MediaRenderer synchronizes, through ControlPoint 130, the first MediaServer 110 and the second MediaServer 120 by manipulating ControlDirectory services. The synchronization of the two MediaServers requires the ControlPoint 130 to first perform synchronization setup through sync information, such as sync pairing, sync partnership, synchronization policy, etcetera for objects in the respective MediaServers, stored in ControlPoint 130. Synchronization setup refers to a process of providing synchronization information to the two MediaServers.

The ControlPoint 130 locates metadata from the destination MediaServer using ContentDirectory:Browser( ) or Search( ) functions. The ControlPoint 130 or a MediaServer then compares the metadata of the source MediaServer and the destination MediaServer. A MediaServer capable of comparing the metadata of the objects would have an extended CDS. The extended CDS has a new UPnP action defined as CDS::CompareMetadata. Having the comparison at the MediaServer would only require a request and the object of the other MediaServers from the ControlPoint. The ControlPoint 130 based on the comparison invokes appropriate universal plug and play (UPnP) action from the respective ContentDirectory of the MediaServers. The UPnP action can include create or delete ContentDirectory services (CDS) containers or items. The metadata of created, updated, or deleted corresponding objects are transferred from the source MediaServer and the destination MediaServer through the ControlPoint.

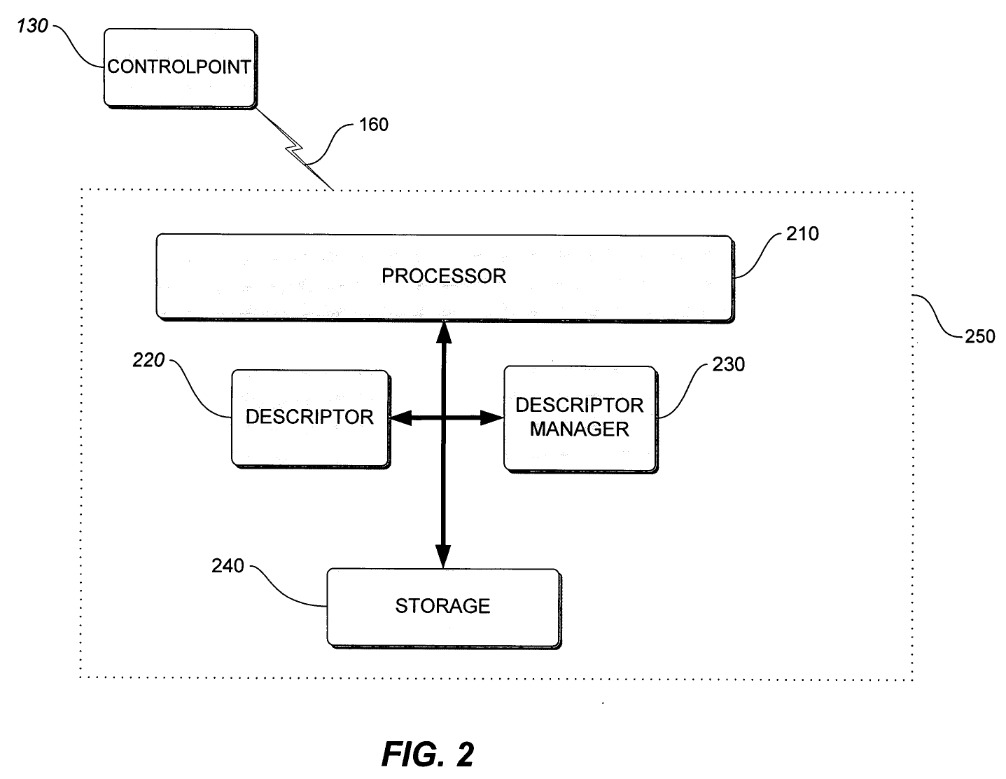

FIG. 2 shows a more detailed exemplary block diagram of a ContentDirectory Service(CDS) 250 in communication with ControlPoint 130 in accordance with a possible embodiment of the invention. In particular, the illustrated CDS 250 service includes descriptor 220, description manager 230, and storage device 240. As noted above the ControlPoint 130 supports synchronization of the CDS devices in the MediaServer/MediaRenderer to manage content such as video, audio, multimedia, etcetera. The descriptor 220 contains the synchronization information for synchronization with target CDS devices such as CDS 122. The synchronization information includes identification information of objects (ObjectID) which are to be synchronized, information regarding changes in the objects, and information regarding synchronization policy. Additionally, the synchronization information includes information regarding a listing and pairing of objects that are to be synchronized. The synchronization information may be generated, modified, or deleted by an internal command from the MediaServer or from an external command such as from ControlPoint 130. The descriptor manager 230 manages descriptor 220 and determines the difference between the objects to be synchronized by a UPnP action defined:CDS::CompareMetadata(<in >MetaData,<in >objectID, <out>metadataDifference). Where the action has as inputs MetaData of an object from a source MediaServer and the ObjectID of a object of a destination MediaServer. The output is a set of metadataDifference parameters. The metaDifference parameters are encapsulated into an XML document following a defined style sheet. The storage unit 240 obtains and stores information regarding changes in the synchronization information, and metaDifference parameters. Processor 210 performs synchronization, the CompareMetadata action, and other functions required by the CDS device 250. Processor 210 may include at least one conventional processor or microprocessor that interprets and executes machine readable instructions. The execution of the machine readable instruction by processing platform results in the metadata difference parameters for exchanging content between the content directory service devices such as mediaserver 110. Processor 210 may employ random access memory (RAM) or another type of dynamic storage device that stores information and instructions for execution by the processor. Additionally, the processor may include a conventional ROM device or another type of static storage device that stores static information and instructions for processor 210. Storage device 240 may include any type of media, such as, for example, magnetic or optical recording media and its corresponding drive.

The UPnP network 100 and the MediaServers illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

For illustrative purposes, the synchronization process will be described below in relation to the block diagrams shown in FIGS. 1-2.

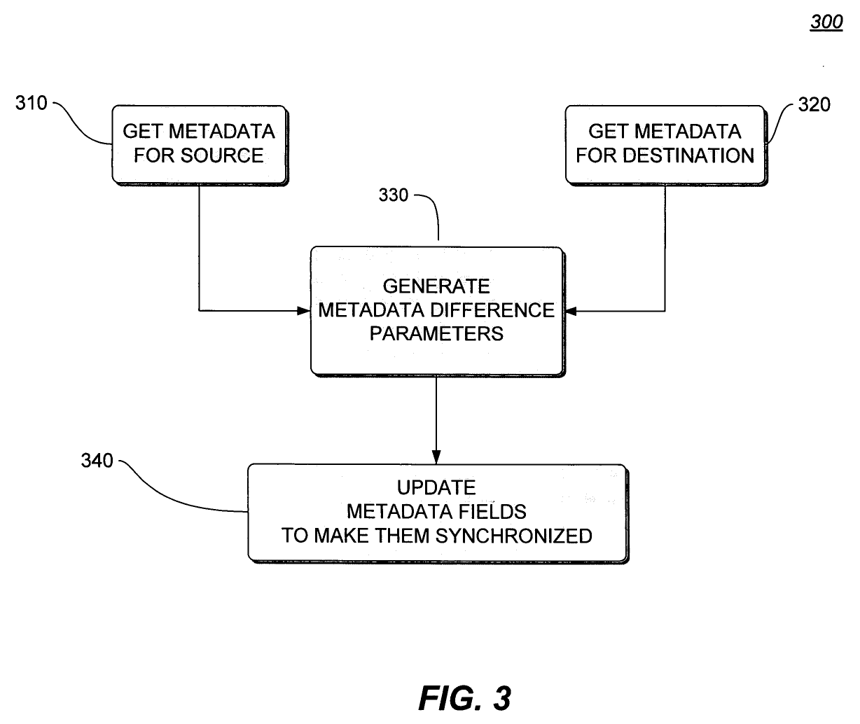

FIG. 3 is an exemplary flowchart illustrating some of the basic steps associated with synchronization process 300 in accordance with a possible embodiment of the invention. The synchronization process begins at step 310 where the metadata for the source object is acquired through a Browse( )/Search( ) procedure. The source object could be an object in ContentDirectory 112 that is paired or partnered with an object in second MediaServer 120. As noted above a representative metadata for an exemplary object was described as follows: <item id=“A1” parentID=“00000001” restricted=“1”>

<dc:title>music1</dc:title>
<dc:artist>unKnow</dc:creator>
<dc:creator>Frank</dc:creator>
<upnp:class>object.item</upnp:class>
</item>

The acquired metadata is passed to step 330 for further processing. In addition, step 330 receives the metadata object for the destination object that in most cases is internal to the MediaServer. The destination object is acquired based on the ObjectID parameter that uniquely identifies an object that is stored in the invoked CDS such as CDS 122. Once the metadata for the source object and the metadata for the destination object have been acquired a difference is determined.

In step 330, a metadata difference parameter is ascertained from the respective metadata of the objects. The metadata difference compares a source metadata fields (A1) with destination metadata fields of the invoked object (B1) by a CompareMetaData action performed at the destination MediaServer such as MediaServer 120, the source MediaServer, or the ControlPoint. The output or metadataDifference of the CompareMetaData action is then packaged into an XML document having the following structural definition: <MetadataDifference>dc:title, dc:artist, −dc:creator, +dc:producer</MetadataDifference> Where, the “−” prefix means the “dc:creator” property is deleted in the invoked object (B1) compared with input MetaData (A1); and the “+” prefix means the “dc:producer” is added into the invoked object (B1) compared with input MetaData (A1).

The metadataDifference parameter can be defined in another way:

<MetadataDifference>
<modified>
<dc:title>I will always love you</dc:title>
<dc:artist>Sting</dc:creator>
</modified>
<delete>dc:creator</delete>
<add>
<dc:producer>Sony</dc:producer>
</add>
</MetadataDifference>

The generated metadata difference parameters from step 330 are passed to step 340 for further processing. Based on the MetadataDifference parameter returned and the synchronization policy assigned an appropriate UPnP action such as CDS::UpdateObject( ), CDS::createObject( ), CDS:destroyObject( ), etcetera is invoked to ensure the two objects are synchronized.

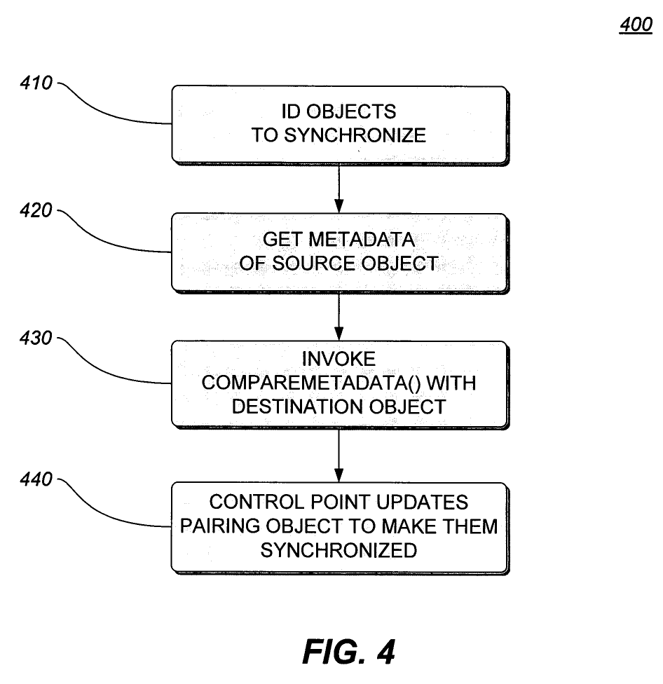

FIG. 4 is an exemplary flowchart illustrating some of the basic steps associated with a process 400 for content synchronization with CompareMetadata action in accordance with a possible embodiment of the invention.

Process 400 begins with the identification of objects to be synchronized. Such identification is possible by maintaining synchronization information that includes synchronization pairing and synchronization partnership maintained in a storage device like at ControlPoint 130. A possible synchronization information MetaData description is illustrated as follows:

```
<sync_information>
<sync_partner ServiceID=”S_A” peerServiceID=”S_B”>
<sync_pairing object=”A1” peerobject=”B1”>
<sync_pairing object=”A2” peerobject=”B2”>
                    .
                    .
                    .
</sync_partner>
<sync_information>
```

The ServiceID identifies one CDS such as CDS 112, and the peerServiceID identifies another CDS such as CDS 122. Both CDS can have CompareMetadata ( ) action support. In the above metadata structure the peerServiceID identifies the CDS that supports the CompareMetadata ( ) action. The <sync-pairing> contains pairing information for the two objects to be synchronized. It should be noted that other combinations and pairing are within the scope of the CompareMetadata( ) action. The first object is stored in CDS “S_A” such as in first MediaServer 110, the second one is stored in CDS “S_B” such as second MediaServer 120. Appropriate content rules or synchronization policy could be inserted in the synchronization information structure. Further, the synchronization structure could be as an XML document. It should be noted that different implementations could defined different synchronization information structures. After identification of the set of objects to synchronized control passes to step 420 for further processing.

In step 420, the metadata of the source object is obtained form the MediaServer that host or maintains that object in the ContentDirectory service such as CDS 112. The ControlPoint 130 from the synchronization information identifies (ServiceID) the object, and using a browse/search action the object is acquired. After the source object is obtained control passes to step 430 for further processing.

In step 430, a CompareMetaData( ) action is invoked. The ControlPoint 130 from the synchronization information is able to ascertain the objects and the ContentDirectory service such as CDS 122 that can perform the CompareMetaData( ) action. The serviceId identifies the peerServiceID the can perform the CompareMetadata( ) action. It should be noted that the comparison of the metadata for the objects can be performed by MediaServers not involved in the transfer of the objects. The CompareMetaData action could be a service offered by another device. Once the CompareMetaData( ) action is performed the CDS returns XML difference data or metadataDifference parameter, wherein the XML difference data are fragments of XML document. Control is then passed to step 440 for further processing.

In step 440, the ControlPoint updates pairing objects to make them synchronized. Based on the metadataDifference parameter returned (step 430) and the synchronization policy assigned, ControlPoint 130 invokes appropriate UPnP actions such as CDS::UpdateObject( ), CDS::createObject( ), CDS:destroyObject( ), etcetera to ensure the two objects are synchronized.

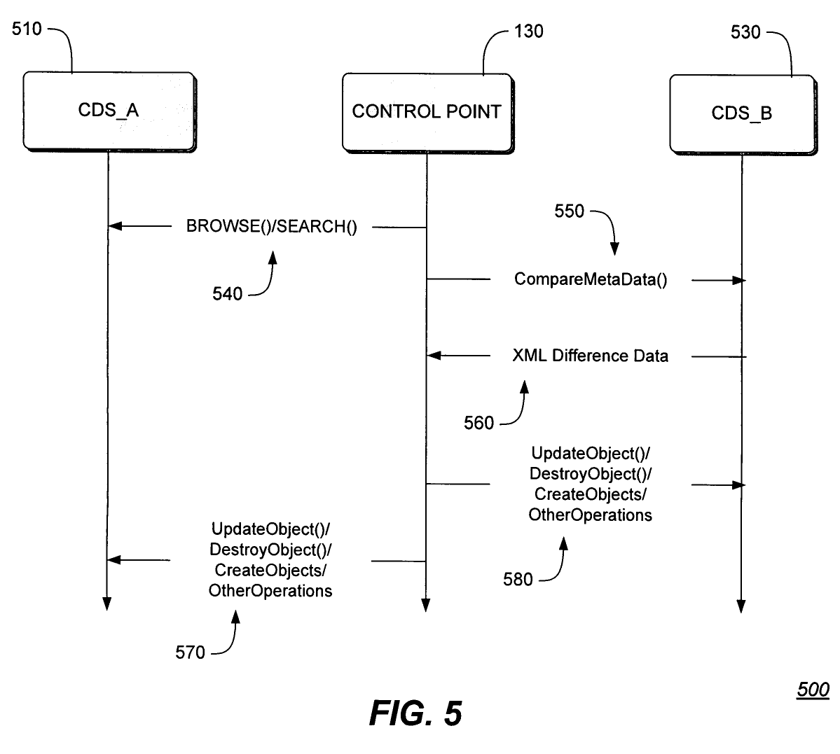

FIG. 5 illustrates a process of synchronizing two CDS devices according to an exemplary embodiment of the present invention. The ControlPoint 130 discovers at least one destination mediaserver such as CDS_B 530 and at least one source mediaserver such as CDS_A 510 coupled to the network, wherein each MediaServer has a repository of metadata fields. Controlpoint 130 as noted earlier has machine readable instruction that when used by a processing platform results in the facilitation of content between the mediaservers. Controlpoint 130 has a storage device (not shown) storing in the control point synchronizing information that comprise synchronizing pairings and synchronizing partnerships of the respective content directory service device such as MediaServer 110. Synchronization information in CP 130 includes pairing information for objects to be compared and synchronized in the respective mediaservers. CP 130 uses a browse( )/search( ) action 540 to request from CDS_A 510 a set of objects identified by a ServiceID parameter in the synchronization information. After receiving the requested set of objects from CDS_A 510 the CP 130 request CompareMetaData( ) 550 action from CDS_B 530. CDS_A 510 and CDS-B 530 compose a synchronization partnership where CDS_A is defined by a common UPnP procedure and where CDS_B is an extended UPnP procedure having a CDS:CompareMetaData action. After receiving the request from CP 130, CDS_B 530 performs the CompareMetaData action. CDS_B produces and returns a XML difference data or MetadataDifference parameter to CP 130, where the XML difference data is fragments of XML document. Based on the returned metadataDifference parameter and the synchronization policy assigned, the CP will invoke appropriate upnp actions (CDS::UpdateObject( ), CDS::createObject( ), CDS:destroyObject( ), etcetera) to ensure the two objects are synchronized. The ControlPoint 130 can update and delete CDS containers or items based on the XML difference data.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the in FIGS. 1—each processing the content in various possible ways. It does not necessarily need to be one system used by all end users. Accordingly, the appended claims and their legal equivalents should only define the invention, rather than any specific examples given.

We claim:

1. A method of synchronizing media servers in a network having a control point, the method comprising:
discovering at least one destination media server and at least one source media server coupled to the network, wherein each media server has a repository of metadata fields;
comparing the metadata fields of the at least one destination media server and the at least one source media server so as to generate metadata difference parameters; and
updating the metadata fields of the at least one destination media server and the at least one source media server based on the generated metadata difference parameters.

2. The method of claim 1, wherein the network is based on universal plug and play audio/video architecture.

3. The method of claim 2, wherein the at least one destination media server or the at least one source media server have a comparemetadata action.

4. The method of claim 3, the method further comprising:
storing in the control point synchronizing information that comprise pairing and partnership of media servers coupled to the network.

5. The method of claim 4, wherein comparing the metadata fields includes identifying pairing objects in the synchronizing information.

6. The method of claim 3, wherein updating the metadata fields is at least one of updateobject, destroyobject, createobjects, create metadata field.

7. The method of claim 3, wherein the comparemetadata action include as inputs metadata fields from the at least one destination media server and the at least one source media server; and
wherein the comparemetadata action returns XML difference data, wherein the XML difference data are fragments of XML documents.

8. A content directory service device comprising:
a synchronization descriptor which comprises synchronization information for synchronization with other content directory service device, wherein each content directory service device has a repository of metadata fields;
a synchronization descriptor management unit for comparing the synchronization descriptor of at least one destination content directory service device and at least one source content directory service device so as to generate metadata difference parameters; and
an embedded control point for exchanging the synchronization information with the other CDS device, wherein the synchronization information includes the generated metadata difference parameters.

9. The device of claim 8, wherein content directory service device and control point are networked based on universal plug and play audio/video architecture.

10. The content directory service device of claim 9, wherein the at least one destination content directory service device or the at least one source content directory service device have a comparemetadata action.

11. The device of claim 10, the device further comprising:
storing in the control point synchronizing information that comprise synchronizing pairings and synchronizing partnerships of the at least one destination content directory service device and the at least one source content directory service device coupled to the network.

12. The device of claim 11, wherein comparing the metadata fields includes identifying pairing objects in the synchronizing information.

13. The device of claim 10, wherein updating the metadata fields is at least one of updateobject, destroyobject, createobjects, create metadata field.

14. The method of claim 10, wherein the comparemetadata action includes as inputs the at least one source content directory service device metadata fields and selected metadata fields from the at least one destination content directory service device; and
wherein the comparemetadata action returns XML difference data, wherein the XML difference data are fragments of XML document.

15. An article of manufacture comprising a tangible medium having machine readable instructions stored thereon to synchronize media servers in a network having a control point, the machine readable instructions when executed by a processing platform results in:
discovering at least one destination media server and at least one source media server coupled to the network, wherein each media server has a repository of metadata fields;
comparing the metadata fields of the at least one destination media server and the at least one source mediaserver so as to generate metadata difference parameters; and
updating the metadata fields of the at least one destination media server and the at least one source media server based on the generated metadata difference parameters.

16. The article of claim 15, wherein the network is based on universal plug and play audio/video architecture.

17. The article of claim 16, wherein the at least one destination media server or the at least one source media server have a comparemetadata action.

18. The article of claim 17, the processing platform further results in:
storing in the control point synchronizing information that comprise synchronizing pairings and synchronizing partnerships of the at least one destination media server and the at least one source media server coupled to the network.

19. The article of claim 18, wherein comparing the metadata fields includes identifying pairing objects in the synchronizing information.

20. The article of claim 17, wherein updating the metadata fields is at least one of updateobject, destroyobject, createobjects, create metadata field;
wherein the comparemetadata action includes as inputs the at least one source media server metadata fields and selected metadata fields from the at least one destination media server; and
wherein the comparemetadata action returns XML difference data, wherein the XML difference data are fragments of XML document.
